(19) United States
(12) Patent Application Publication
(10) Pub. No.: US 2010/0088466 A1
(43) Pub. Date: Apr. 8, 2010

(54) STORAGE DEVICE, STORAGE CONTROL DEVICE, AND CONTROL METHOD

(75) Inventors: Hironori NAKANISHI, Ome-shi (JP); Takeshi KIKUCHI, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/633,699

(22) Filed: Dec. 8, 2009

Related U.S. Application Data
(63) Continuation of application No. PCT/JP2007/061606, filed on Jun. 8, 2007.

(51) Int. Cl. G06F 12/02

(52) U.S. Cl. 711/103; 711/E12.008

(57) ABSTRACT

According to one embodiment, a storage device includes an actuator to move a head to a position on a disk medium; a module to record or reproduce data to or from the disk medium using the head; a memory controller to write or read to or from a non-volatile memory; a buffer controller to write or read to or from a buffer memory; an interface controller to transmit and receive to or from an upper device; a switching module to switch data transfer paths among the module, the memory controller, and the interface controller; and an access controller to control the switching module to transfer data read from the non-volatile memory to the upper device concurrently with transferring and storing the read data in a cache region of the buffer memory, upon receiving from the upper device a command to read the data from the non-volatile memory.

### CROSS-REFERENCE TO RELATED APPLICATIONS

This application is a continuation of PCT international application Ser. No. PCT/JP2007/061606 filed on Jun. 8, 2007 which designates the United States, the entire contents of which are incorporated herein by reference.

### BACKGROUND

1. Field

One embodiment of the invention relates to a storage device, a storage control device, and a control method, which use a magnetic disk and a non-volatile memory as storage media.

2. Description of the Related Art

In recent years, with increase in storage capacities of flash memories, which are non-volatile memories and reduction in costs, hybrid storage devices have been proposed in which flash memories are provided as storage media in magnetic disk devices (see Japanese Patent Application Publication (KOKAI) Nos. 2005-209119 and 2003-233529).

In such a hybrid storage device, since read and write access times for a flash memory are shorter than those for a magnetic disk, random data that need to be processed at a high speed by an OS of a host are stored in the non-volatile memory and stream data that need to be continuously processed are stored in a magnetic disk.

Upon receiving at the hybrid storage device from the host a read command directed to the non-volatile memory, the firmware of the device controls data transfer as illustrated in a timing chart of FIG. 13. Upon receiving a read request 100-1 directed to the non-volatile memory from the host as illustrated at (C) in FIG. 13, as illustrated at (A) in FIG. 13, a load command is issued to the nonvolatile memory, upon the nonvolatile memory being enabled to perform reading, the load command is completed (104-1), and transfer data 106-11 are read from the nonvolatile memory to be stored in the buffer memory as illustrated at (B) in FIG. 13. Subsequently, transfer data 106-13 are read from the buffer memory and transferred as transfer data 106-14 to the host.

As such, for the conventional read request with respect to the nonvolatile memory, the reading speed from the non-volatile memory is different from the transfer speed to the host, and thus the data are asynchronously transferred via the buffer memory.

As illustrated at (A) in FIG. 14, if subsequently to FIG. 13, a re-read request 100-2 to read the same data from the non-volatile memory is received from the host, similarly to the first read request, as illustrated at (A) in FIG. 14, a load command is issued to the non-volatile memory, upon being enabled, the load command is completed (104-2), and transfer data 106-21 read from the non-volatile memory are stored as transfer data 106-22 in the buffer memory to be read as transfer data 106-23 from the buffer memory and transferred as transfer data 106-24 to the host.

Sometimes, the data stored in the non-volatile memory may be written back to the magnetic disk. The write-back operation is performed according to a write-back command from the host or a write-back request by the firmware to reserve a free space region in the non-volatile memory.

As illustrated in FIG. 15, if it is determined that there are corresponding data in the non-volatile memory in response to a write-back request 108 (non-volatile memory hit 110), as illustrated at (A) in FIG. 15, a load command 112 is issued to the non-volatile memory. When enabled, the load command is completed (114). Then, transfer data 106-31 read from the non-volatile memory are stored as transfer data 106-32 in the buffer memory, as illustrated at (B) in FIG. 15. Subsequently, the data are read as transfer data 106-33 from the buffer memory and written back as transfer data 106-34 to the magnetic disk, as illustrated at (D) in FIG. 15.

In the write-back operation, since a reading speed from the non-volatile memory is different from a writing speed to the magnetic disk, data are asynchronously transferred via the buffer memory.

However, in such a conventional hybrid storage device, data read from a non-volatile memory are transferred to a host via a buffer memory. Therefore, it takes more time to transfer the read data to the host for the transfer via the buffer memory.

Further, data are written back from the non-volatile memory to the magnetic disk via the buffer memory. Therefore, it takes more time to transfer the write-back data to the magnetic disk for the transfer via the buffer memory.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating a storage device according to an embodiment of the invention;

FIG. 2 is an exemplary timing chart illustrating the simultaneous transfer of data from a non-volatile memory to a host and a buffer memory in the embodiment;

FIG. 3 is an exemplary timing chart illustrating the details of the data transfer illustrated in FIG. 2;

FIG. 4 is an exemplary timing chart illustrating data transfer when a cache hit occurs in response to a read request for the non-volatile memory in the embodiment;

FIG. 5 is an exemplary timing chart illustrating the details of the data transfer illustrated in FIG. 4;

FIG. 6 is an exemplary timing chart illustrating data transfer when a cache hit occurs in response to a write-back request for the non-volatile memory in the embodiment;

FIG. 7 is an exemplary timing chart illustrating data transfer when a cache hit occurs in response to a write-back request for the non-volatile memory and data transfer when another data item read from the non-volatile memory are prefetched to a cache during an idle time in the embodiment;

FIG. 8 is an exemplary flowchart illustrating a control process of a magnetic disk device in the embodiment;

FIG. 9 is an exemplary flowchart illustrating the details of a write process in S6 of FIG. 8;

FIG. 10 is an exemplary flowchart illustrating the details of a read process in S8 of FIG. 8;

FIG. 11 is an exemplary flowchart illustrating the details of a write-back process in S11 of FIG. 8;

FIG. 12 is an exemplary flowchart illustrating a control process of the non-volatile memory in the embodiment;

FIG. 13 is an exemplary timing chart illustrating the transfer of data to the host in response to a read request for a non-volatile memory according to the related art;

FIG. 14 is an exemplary timing chart illustrating the transfer of data to the host in response to a re-read request for the non-volatile memory according to the related art; and

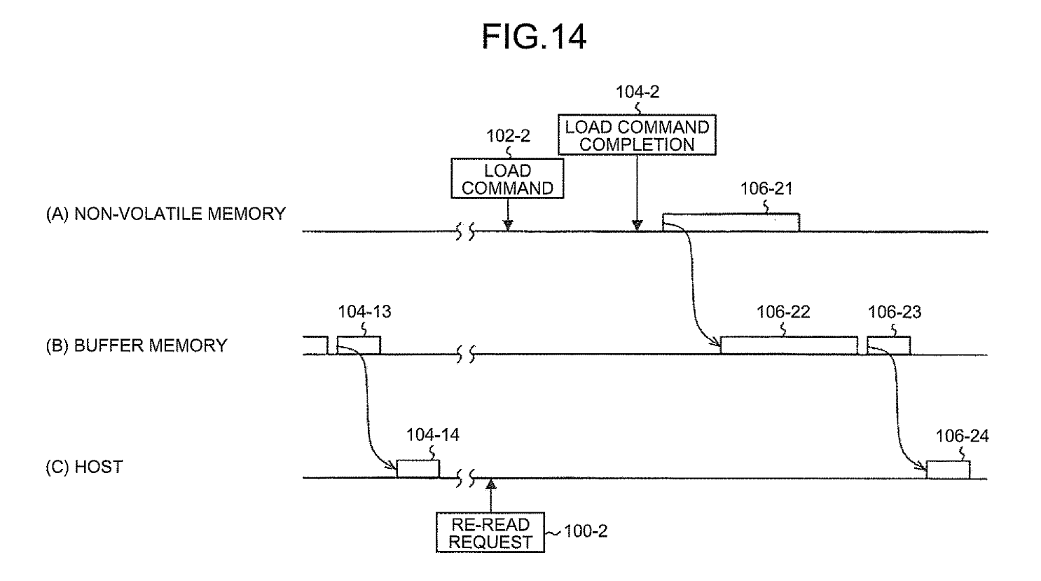

FIG. 15 is an exemplary timing chart illustrating data transfer in response to a write-back request to write back data from the non-volatile memory to a magnetic disk according to the related art.

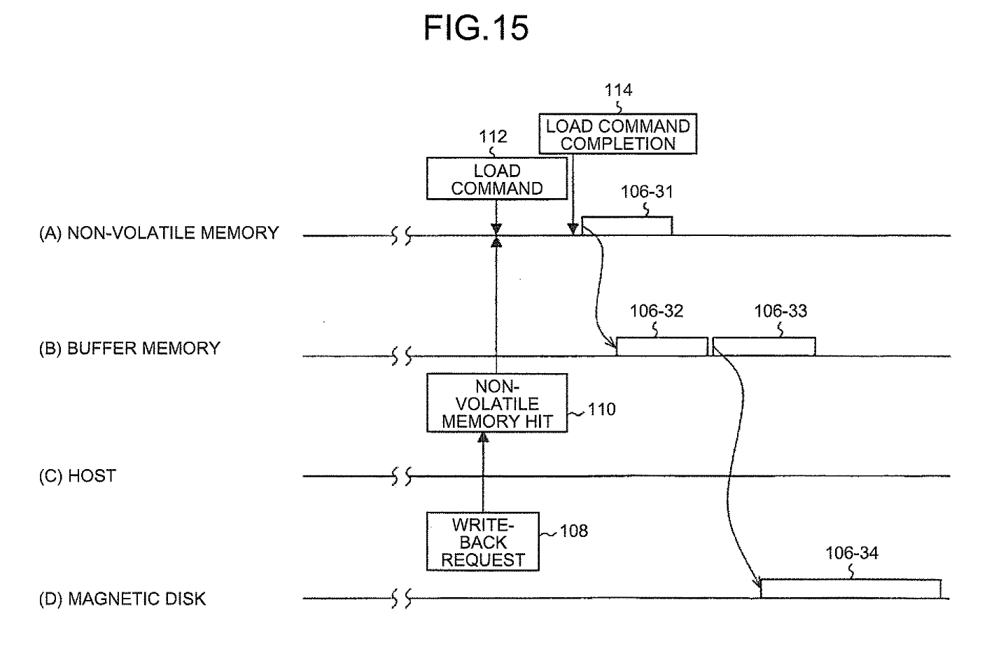

### DETAILED DESCRIPTION

Various embodiments according to the invention will be described hereinafter with reference to the accompanying drawings. In general, according to one embodiment of the invention, a storage device comprises: a head actuator configured to move a head to an arbitrary position on a disk medium; a disk recording/reproducing module configured to record or reproduce data to or from the disk medium using the head; a non-volatile memory controller configured to write or read information to or from a non-volatile memory; a buffer controller configured to write or read information to or from a buffer memory; an upper interface controller configured to transmit and receive a command and data to or from an upper device; a transfer path switching module configured to switch data transfer paths among the disk recording/reproducing module, the non-volatile memory controller, and the upper interface controller; and an access controller configured to control the transfer path switching module to transfer data read from the non-volatile memory to the upper device concurrently with transferring and storing the read data in a cache region of the buffer memory, upon receiving from the upper device a data read command to read the data from the non-volatile memory.

According to another embodiment of the invention, a storage control device comprises: a disk recording/reproducing module configured to record or reproduce data to or from a disk medium using a head; a non-volatile memory controller configured to write or read information to or from a non-volatile memory; a buffer controller configured to write or read information to or from a buffer memory; an upper interface controller configured to transmit and receive a command and data to or from an upper device; a transfer path switching module configured to switch data transfer paths among the disk recording/reproducing module, the non-volatile memory controller, and the upper interface controller; and an access controller configured to control the transfer path switching module to transfer data read from the non-volatile memory to the upper device concurrently with transferring and storing the read data in a cache region of the buffer memory, upon receiving from the upper device a data read command to read the data from the non-volatile memory.

According to still another embodiment of the invention, a method controls a storage device that comprises: a head actuator configured to move a head to an arbitrary position on a disk medium; a disk recording/reproducing module configured to record or reproduce data to or from the disk medium using the head; a non-volatile memory controller configured to write or read information to or from a non-volatile memory; a buffer controller configured to write or read information to or from a buffer memory; an upper interface controller configured to transmit and receive a command and data to or from an upper device; and a transfer path switching module configured to switch data transfer paths among the disk recording/reproducing module, the non-volatile memory controller, and the upper interface controller. The method comprises: controlling the transfer path switching module to transfer data read from the non-volatile memory to the upper device concurrently with transferring and storing the read data in a cache region of the buffer memory, upon receiving from the upper device a data read command to read the data from the non-volatile memory.

According to still another embodiment of the invention, a controller is provided for a storage device that comprises at least: a head actuator configured to move a head to an arbitrary position on a disk medium; a disk recording/reproducing module configured to record or reproduce data to or from the disk medium using the head; a non-volatile memory controller configured to write or read information to or from a non-volatile memory; a buffer controller configured to write or read information to or from a buffer memory; and an upper interface controller configured to transmit and receive a command and data to or from an upper device. The controller comprises: a transfer path switching controller configured to perform control of switching data transfer paths among the disk recording/reproducing module, the non-volatile memory controller, and the upper interface controller; and an access controller configured to control the transfer path switching module to transfer data read from the non-volatile memory to the upper device concurrently with transferring and storing the read data in a cache region of the buffer memory, upon receiving from the upper device a data read command to read the data from the non-volatile memory.

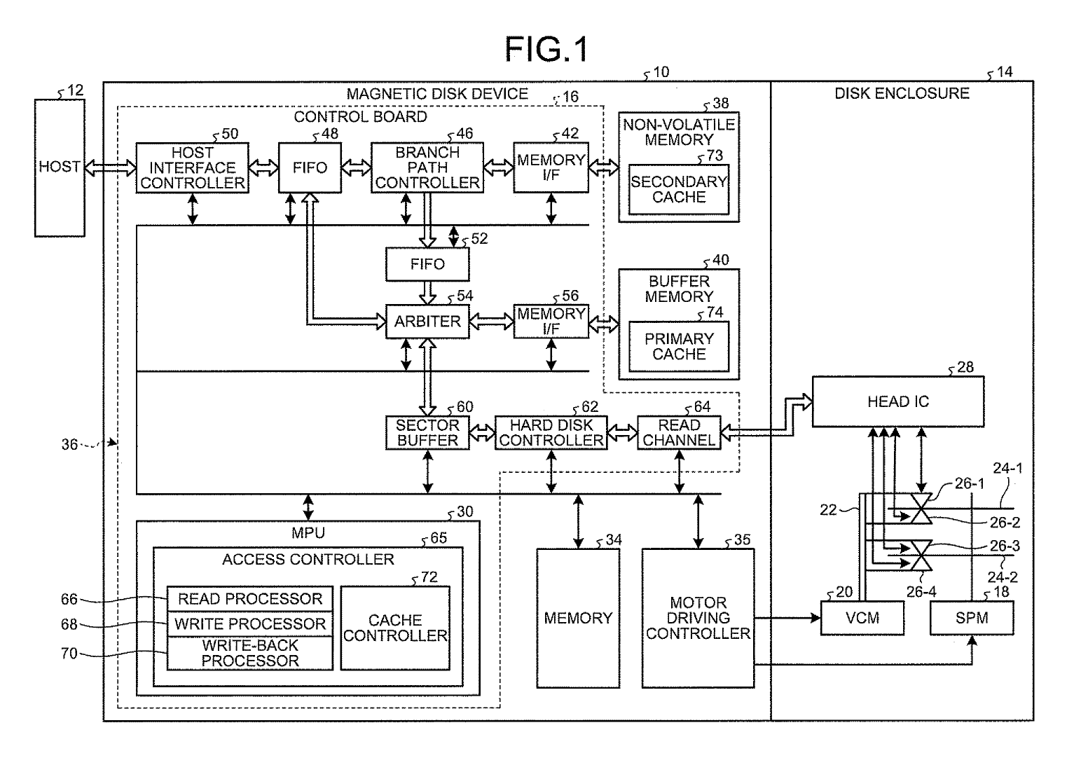

FIG. 1 is a block diagram illustrating a magnetic disk device according to an embodiment of the invention. In FIG. 1, a magnetic disk device 10 known as a hard disk drive (HDD) is connected to a host 12, which is a higher-level device, and comprises a disk enclosure 14 and a control board 16.

The disk enclosure 14 is provided with a spindle motor 18. Magnetic disks 24-1 and 24-2 are attached to a rotating shaft of the spindle motor 18 and are rotated at a constant speed of, for example, 4200 rpm.

In addition, the disk enclosure 14 is provided with a voice coil motor 20. The voice coil motor 20 supports heads 26-1 to 26-4 at the leading end of an arm of a head actuator 22 and determines the positions of the heads relative to the recording surfaces of the magnetic disks 24-1 and 24-2.

The heads 26-1 to 26-4 are hybrid heads in which a recording element and a read element are integrated with each other. An in-plane recording element or a vertical magnetic recording element is used as the recording element. When the vertical magnetic recording element is used, vertical recording media each having a recording layer and a soft magnetic underlying layer are used as the magnetic disks 24-1 and 24-2. A GMR element or a TMR element is used as the read element.

The heads 26-1 to 26-4 are connected to a head IC 28 through signal lines, and the head IC 28 selects one of the heads in response to a head selection signal and performs a write or read operation based on a write command (write request) or a read command (read request) from the host 12. The head IC 28 comprises a write drive provided for a write system and a pre-amplifier provided for a read system.

The control board 16 is provided with an MPU 30 and reads a control program and control data from a RAM through a bus of the MPU 30. The control board 16 is also provided with a memory 34 and a motor driving controller 35 that controls the driving of the spindle motor 18 and the voice coil motor 20.

A non-volatile memory 38 is connected to the MPU 30 through a memory interface 42 serving as a memory controller. Similarly, a buffer memory 40 is connected to the MPU 30 through a memory interface 56 serving as a memory controller.

In this embodiment, firmware, which is a control program of the magnetic disk device 10 executed by the MPU 30, is recorded on the non-volatile memory 38 and data are also stored in the non-volatile memory 38. Therefore, the magnetic disk device 10 according to this embodiment is a hybrid storage device that comprises the non-volatile memory 38, serving as a data storage destination, in addition to the magnetic disks 24-1 and 24-2.

For example, a flash memory is used as the non-volatile memory 38. Data are written to or read from the flash memory in units of a predetermined data size, for example, in units of 8-kilobyte or 64-kilobyte block.

A RAM is used as the buffer memory 40, and data are written to or read from the buffer memory 40 in units of a predetermined burst length.

The non-volatile memory 38 used to store data in this embodiment actually requires a storage capacity of about 1 GB. In contrast, the buffer memory 40 requires a storage capacity of, for example, about 64 MB.

A sector buffer 60, a hard disk controller 62, and a read channel 64 are provided for the bus of the MPU 30 such that the heads 26-1 to 26-4 record or reproduce data on or from the magnetic disks 24-1 and 24-2. Circuit modules from the sector buffer 60 to the head IC 28 form a disk recording/reproducing module.

A host interface controller 50, serving as an upper interface controller, is provided between the host 12 and the bus of the MPU 30 and transmits commands and data therebetween. For example, a serial ATA interface is used as the host interface controller 50.

In this embodiment, transfer path switching modules for switching data transfer paths are provided between the disk recording/reproducing module comprising the head IC 28, and the host interface controller 50 close to the host 12, the memory interface 42 close to the non-volatile memory 38, the memory interface 56 close to the buffer memory 40, and the sector buffer 60 close to the heads 26-1 to 26-4 that record or reproduce data on or from the magnetic disks 24-1 and 24-2.

In the transfer path switching module, a branch path controller 46 and a FIFO (first FIFO) 48 are provided from the memory interface 42 close to the non-volatile memory 38, and a FIFO (second FIFO) 52 and an arbiter 54 are provided between the branch path controller 46 and the memory interface 56 close to the buffer memory 40. The FIFO 48 and the sector buffer 60 are connected to the arbiter 54. The FIFO means a first-in-first-out memory.

The MPU 30 is provided with an access controller 65 that is implemented by reading firmware recorded on the non-volatile memory 38 to the memory 34 and executing the read firmware. The access controller 65 comprises the functions of a read processor 66, a write processor 68, a write-back processor 70, and a cache controller 72.

In this embodiment, the buffer memory 40 is provided with a primary cache 74, and the non-volatile memory 38 is provided with a secondary cache 73. Data read from the non-volatile memory 38 and data read from the magnetic disks 24-1 and 24-2 in response to a read request from the host 12 are stored in the primary cache 74 of the buffer memory 40. Then, when a read request to read the data is issued, write data are read from the buffer memory 40 by a cache hit of the primary cache 74 and the read data are transferred to the host 12.

Data that has been read from the magnetic disks 24-1 and 24-2, cached in the primary cache 74, and output from the primary cache 74 by LRU management are stored in the secondary cache 73 of the non-volatile memory 38.

When receiving a command to read data from the non-volatile memory 38, that is, a read command from the host 12, the read processor 66 provided in the MPU 30 according to this embodiment controls the branch path controller 46 (a transfer path switching control function) to transfer the data read from the non-volatile memory 38 by the memory interface 42 to the host 12 through the FIFO 48 and the host interface controller 50. In addition, the read processor 66 controls the branch path controller 46 to transfer the read data to the buffer memory 40 through the FIFO 52, the arbiter 54, and the memory interface 56, and stores the data in the primary cache 74.

The write speed of the FIFO 48 and the FIFO 52 provided on the branch side of the branch path controller 46 is sufficient higher than the read speed of the non-volatile memory 38. Therefore, the FIFO 48 and the FIFO 52 are maintained in an empty state all the time while data read from the non-volatile memory 38 are being transferred. Therefore, data are continuously read from the non-volatile memory 38 and is then processed in a first-out-manner. Then, the processed data are transferred from the FIFO 48 to the host interface controller 50 and from the FIFO 52 to the buffer memory 40 through the arbiter 54.

When one of the FIFO 48 and the FIFO 52 is out of the empty state due to a certain cause and stops its operation, the write operation on the other FIFO also stops.

In the FIFO 52 that transfers the read data to the buffer memory 40, since data are written to the buffer memory 40 in units of burst length, the storage capacity of the FIFO 52 may be at least twice the burst length of the buffer memory 40. In this case, it is possible to continuously transfer the data read from the non-volatile memory 38 to the buffer memory 40. In this way, the transmission of data from the host interface controller 50 to the host 12 through the FIFO 48 is not prevented.

When the read processor 66 provided in the MPU 30 stores the data read from the non-volatile memory 38 in the primary cache 74 of the buffer memory 40 and receives a command to re-read the same data from the non-volatile memory 38 from the host 12, the cache controller 72 provided in the MPU 30 determines that there is a cache hit with reference to management data of the primary cache 74. In this case, the read processor 66 reads the corresponding data from the primary cache 74 of the buffer memory 40, not the non-volatile memory 38, and transfers the data read from the primary cache 74 to the host 12 through the memory interface 56, the arbiter 54, the FIFO 48, and the host interface controller 50.

For the transfer of data from the non-volatile memory 38 to the host 12 by the hit of the primary cache 74 of the buffer memory 40, data are transferred to the host 12 through the FIFO 48 by the buffer memory 40 in units of burst length. Therefore, as long as the space of the FIFO 48 is more than the burst length, the buffer memory 40 repeatedly performs a process of continuously transferring the read data.

In the transfer of data from the primary cache 74 of the buffer memory 40 to the host, when the storage capacity of the FIFO 48 is at least twice the burst length, which is a read unit of the buffer memory 40, it is possible to transfer data at a maximum transfer rate without interrupting the reading of data from the buffer memory 40.

When the write-back processor 70 provided in the MPU 30 receives a write-back command to write back data from the non-volatile memory 38 to the magnetic disks 24-1 and 24-2, or when the cache controller 72 implemented by the firmware generates a write-back request to write back data from the non-volatile memory 38 to the magnetic disks 24-1 and 24-2, the cache controller 72 searches whether there are corresponding data in the primary cache 74 of the buffer memory 40. When there are corresponding data in the primary cache 74 and a cache hit occurs, the write-back processor 70 read data from the primary cache 74 and writes back the read data to the magnetic disks 24-1 and 24-2.

In the write-back operation of writing back data in the primary cache 74 of the buffer memory 40 to the magnetic disk, a write-back process through the buffer memory 40 in which data are read from the non-volatile memory 38 and is then stored in the buffer memory 40 and the data are read from the buffer memory 40 can reduce the process time.

In this embodiment, in some cases, the host 12 issues a command to store data of the secondary cache 73 of the non-volatile memory 38 in the magnetic disk as a write-back request to write back data from the non-volatile memory 38 to the magnetic disks 24-1 and 24-2.

In the write-back process of the host 12 that writes back data from the non-volatile memory 38 to the magnetic disk, when the host 12 writes data to the non-volatile memory 38, a PIN flag, which is a mark indicating the storage of data in the non-volatile memory 38, is set and stored.

The setting of the PIN flag to write data from the host 12 means that data are stored in the non-volatile memory 38. In this state, the host 12 can reset the PIN flag of the data in the non-volatile memory 38, if necessary.

When the PIN flag of the data stored in the non-volatile memory 38 is reset by the host 12, an operation of writing back the reset data to the magnetic disk is performed.

Therefore, when the host 12 resets the PIN flag of the data stored in the non-volatile memory 38, the write-back processor 70 of the MPU 30 performs a process of writing back the data of the non-volatile memory 38 having the reset PIN flag to the magnetic disk.

There is a write-back process performed by the cache controller 72 as the write-back process executed by the firmware of the magnetic disk device that writes backs the data of the non-volatile memory 38 to the magnetic disk.

In the write-back process performed by the cache controller 72, LRU (Least Recently Used) management is performed on the primary cache 74 of the buffer memory 40 and the secondary cache 73 of the non-volatile memory 38.

First, data of the primary cache 74 to be evicted by the LRU management are written back to the non-volatile memory 38. In this case, when write-back data are cache data of the magnetic disk, the data are written back to the secondary cache 73. When the write-back data are data of the non-volatile memory 38, the data are overwritten on the corresponding data of the non-volatile memory 38.

Data of the secondary cache 73 of the non-volatile memory 38 to be read by the LRU management are written back to the magnetic disks 24-1 and 24-2. In this case, the write-back processor 70 searches whether the data of the secondary cache 73 to be written back are stored in the primary cache 74 of the buffer memory 40. When a cache hit occurs, the write-back processor 70 writes back data from the primary cache 74 of the buffer memory 40 to the magnetic disk.

When the data of the secondary cache 73 are miss-hit by the primary cache 74, the data of the secondary cache 73 are transferred to the buffer memory 40 and is then stored therein. Then, the data are read from the buffer memory 40 and is written back to the magnetic disks 24-1 and 24-2.

When the host interface controller 50 receives a write command, which is a write request, from the host 12, the write processor 68 provided in the MPU 30 writes write data to the buffer memory 40 through the FIFO 48, the arbiter 54, and the memory interface 56, and then transfers and writes the data to the non-volatile memory 38 or the magnetic disks 24-1 and 24-2 designated by the write command.

In this case, when the write data are update data for the primary cache 74 of the buffer memory 40, the write data are overwritten on the data of the primary cache 74 to update the data. Therefore, the updated data are different from that of the non-volatile memory 38 or the magnetic disks 24-1 and 24-2. In this way, a write-back flag is set.

As such, when the data of the primary cache 74 is updated with the write data and the write-back flag is set, the cache controller 72 writes back the data of the primary cache 74 whose write-back flag is set to the non-volatile memory 38 or the magnetic disks 24-1 and 24-2 during the time for which there is no access request from the host 12 such that the data are identical to each other.

When the write command from the host 12 is for the magnetic disks 24-1 and 24-2 and there is a miss hit in the search operation of the primary cache 74 of the buffer memory 40, the secondary cache 73 of the non-volatile memory 38 is searched. When there is a cache hit in the secondary cache 73, the write data are transferred from the buffer memory 40 to the non-volatile memory 38 to update the corresponding data of the secondary cache 73.

In this case, similarly, the write-back flag of the updated data of the secondary cache 73 is set, and in an idle state, the write-back processor 70 reads the data of the secondary cache 73 whose write-back flag is set and writes backs the read data to the magnetic disks 24-1 and 24-2 through the buffer memory 40 such that the data of the secondary cache 73 is identical to the data of the magnetic disks 24-1 and 24-2.

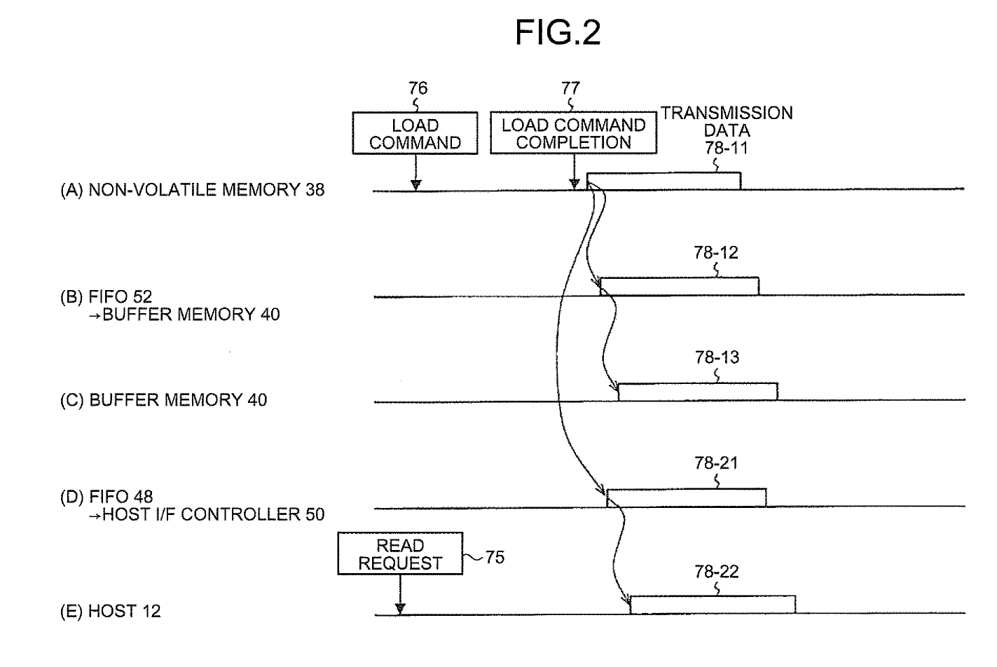

FIG. 2 is a timing chart illustrating a transmission process of simultaneously transferring data read from the non-volatile memory to the host and the buffer memory according to this embodiment.

As illustrated in FIG. 2(E), when receiving a read request (read command) 75 from the host 12, the read processor 66 of the MPU 30 issues a load command 76 to the memory interface 42 of the non-volatile memory 38.

When receiving the load command 76, the memory interface 42 is operated such that data can be read from the non-volatile memory 38. Then, when an enable signal is obtained, a load command completion 77 is performed. When the load command completion 77 is performed, transfer data 78-11 is read from the non-volatile memory 38 and is then output to the memory interface 42.

The transfer data 78-11 output from the non-volatile memory 38 is input to the branch path controller 46, and is then branched to the FIFO 48 and the FIFO 52.

As illustrated in FIG. 2(B), the transfer data branched by the branch path controller 46 is written as transfer data 78-12 to the FIFO 52. Then, the data are read from the FIFO 52 and is than written and stored as transfer data 78-13 in the primary cache 74 through the arbiter 54 by the memory interface 56, as illustrated in FIG. 2(C).

At the same time, the transfer data 78-11 output from the branch path controller 46 is transferred as transfer data 78-21 to the host interface controller 50 through the FIFO 48, as illustrated in FIG. 2(D), and is then transferred from the host interface controller 50 to the host 12, as illustrated in FIG. 2(E).

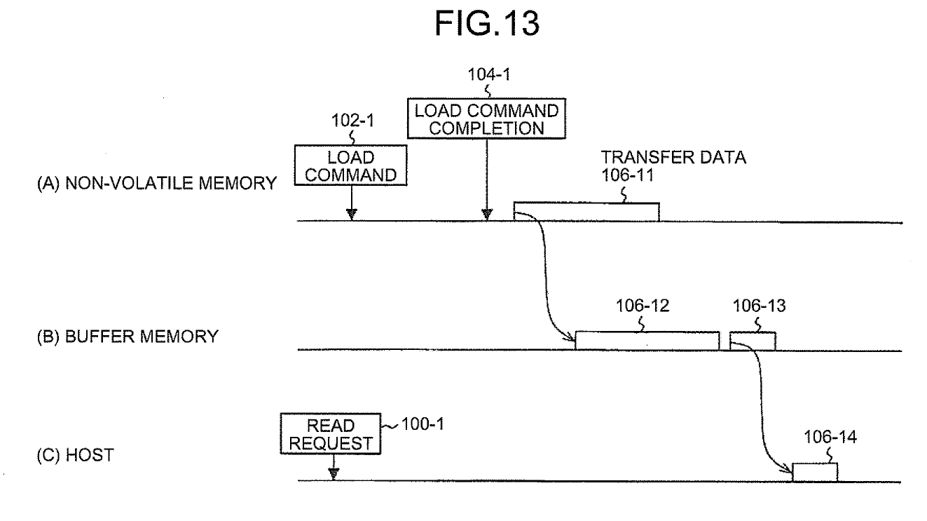

As such, in this embodiment, the transfer data 78-11 read from the non-volatile memory 38 is simultaneously transferred to the buffer memory 40 and the host 12 in parallel. As illustrated in FIG. 13, the transfer data are directly transferred to the host, without passing through the buffer memory, unlike the related art in which data are transferred to the host through the buffer memory. Therefore, it is possible to reduce the transmission time of data to the host. In addition, it is possible to perform cache registration to the primary cache 74 of the buffer memory 40 at the same time as host transmission is performed.

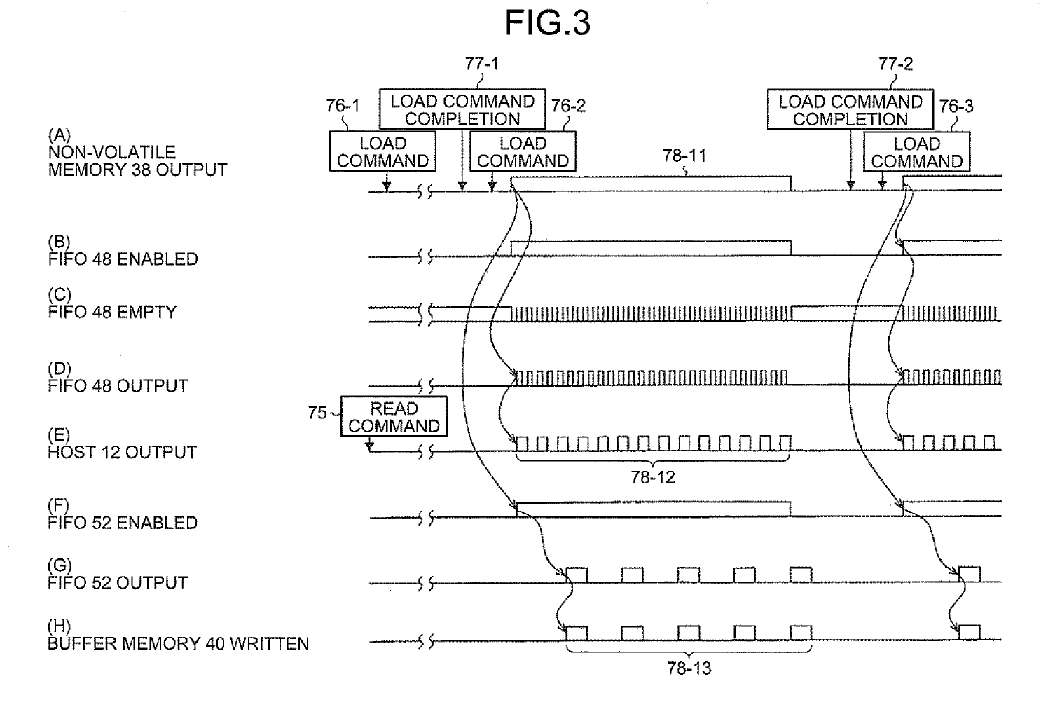

FIG. 3 is a timing chart illustrating the details of the data transmission illustrated in FIG. 2. FIG. 3(A) illustrates the output of the non-volatile memory 38, FIG. 3(B) illustrates the enable state of the FIFO 48, FIG. 3(C) illustrates the empty state of the FIFO 48, FIG. 3(D) illustrates the output of the FIFO 48, FIG. 3(E) illustrates the output of data from the host interface controller 50 to the host 12, FIG. 3(F) illustrates the enable state of the FIFO 52, FIG. 3(G) illustrates the output of the FIFO 52, and FIG. 3(H) illustrates the writing of data to the buffer memory 40.

That is, when receiving a read command 75 as the output of the host 12 in FIG. 3(E), firmware issues a load command 76-1 to the non-volatile memory 38, as illustrated in FIG. 3(A), with the non-volatile memory 38 in a readable state. Then, issuance of the load command is completed (77-1), and the transfer data 78-11 is read from the non-volatile memory 38 and is then output. Then, when a read request is received, issuance of a load command is completed (77-2) after the load command completion 77-1.

When the transfer data 78-11 is read from the non-volatile memory 38 and is then output, the FIFO 48 is enabled, as illustrated in FIG. 3(B), and the transfer data 78-11 from the non-volatile memory 38 is continuously written until a signal indicating the empty state of the FIFO 48 rises, as illustrated in FIG. 3(C).

Since the transmission speed of data written to or read from the FIFO 48 is higher than the read speed of the non-volatile memory 38, as illustrated in FIG. 3(D), the transfer data 78-11 is continuously written to the FIFO 48, and the FIFO 48 repeatedly performs an operation of continuously reading data at a high speed, as illustrated in FIG. 3(D).

The transfer data read from the FIFO 48 is continuously transferred to the host 12 as long as the host interface controller 50 inputs data to the FIFO 48, as illustrated in FIG. 3(E).

Meanwhile, the transfer data 78-11 read from the non-volatile memory 38 is written to the FIFO 52 since the FIFO 52 illustrated in FIG. 3(F) is enabled. When data corresponding to the burst length of the buffer memory 40 is stored in the FIFO 52, as illustrated in FIG. 3(G), the data are written and transferred to the buffer memory 40 illustrated in FIG. 3(H) in units of burst length.

When the transmission of the transfer data 78-11 from the non-volatile memory 38 to the host 12 and the buffer memory 40 is completed, a load command 76-2 corresponding to the next read command is completed (77-2). When there is the next read command, a load command 76-3 is issued. Then, the next transfer data are read from the non-volatile memory 38 and is then transferred to the host 12 and the buffer memory 40.

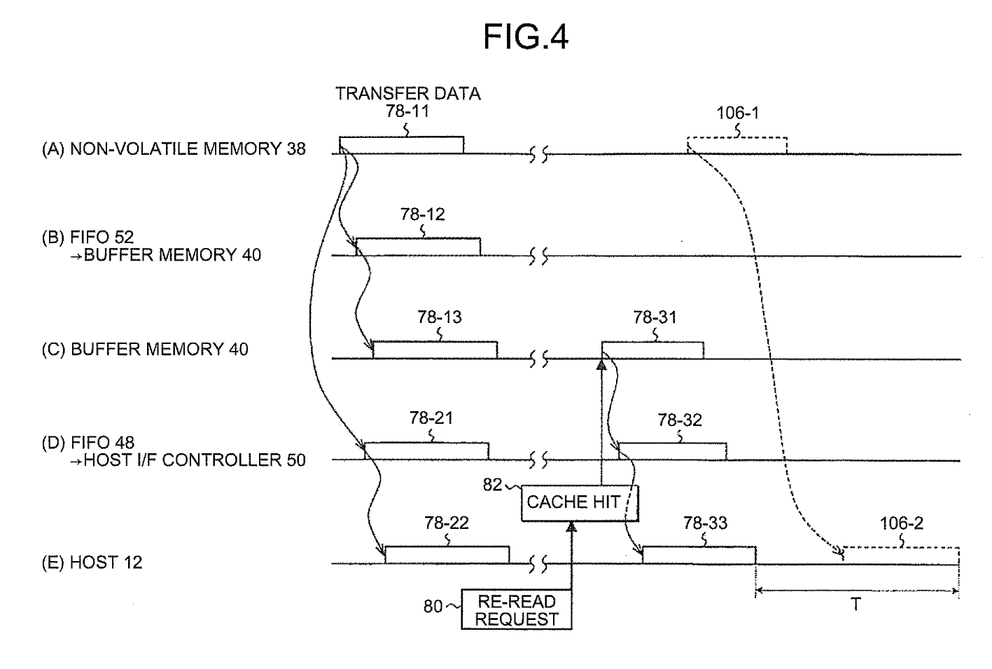

FIG. 4 is a timing chart illustrating data transmission when the transfer data 78-11 is read from the non-volatile memory and is then transferred to the host 12 while being transferred to the buffer memory 40 and then stored in the primary cache 74 and the host 12 issues a request to re-read the same data stored in the non-volatile memory, as illustrated in FIG. 2.

As illustrated in FIG. 4(E), when receiving a re-read request 80 from the host 12, the cache controller 72 searches management data of the primary cache 74 and determines whether there is a cache hit 82. Then, the cache controller 72 reads transfer data 78-31 from the primary cache 74 of the buffer memory 40 illustrated in FIG. 4(C) and transmits transfer data 78-32 to the host interface controller 50 through the arbiter 54 and the FIFO 48, as illustrated in FIG. 4(D). Then, as illustrated in FIG. 4(E), transfer data 78-33 is transferred from the host interface controller 50 to the host 12.

When a cache hit occurs in the primary cache 74 in response to the re-read request 80 from the host 12 to the non-volatile memory 38, it is possible to reduce a process time corresponding to a period T, as compared to when transfer data 106-1 is read from the non-volatile memory 38 without any cache hit and is then transferred as transfer data 106-2 to the host 12, as represented by a dashed line.

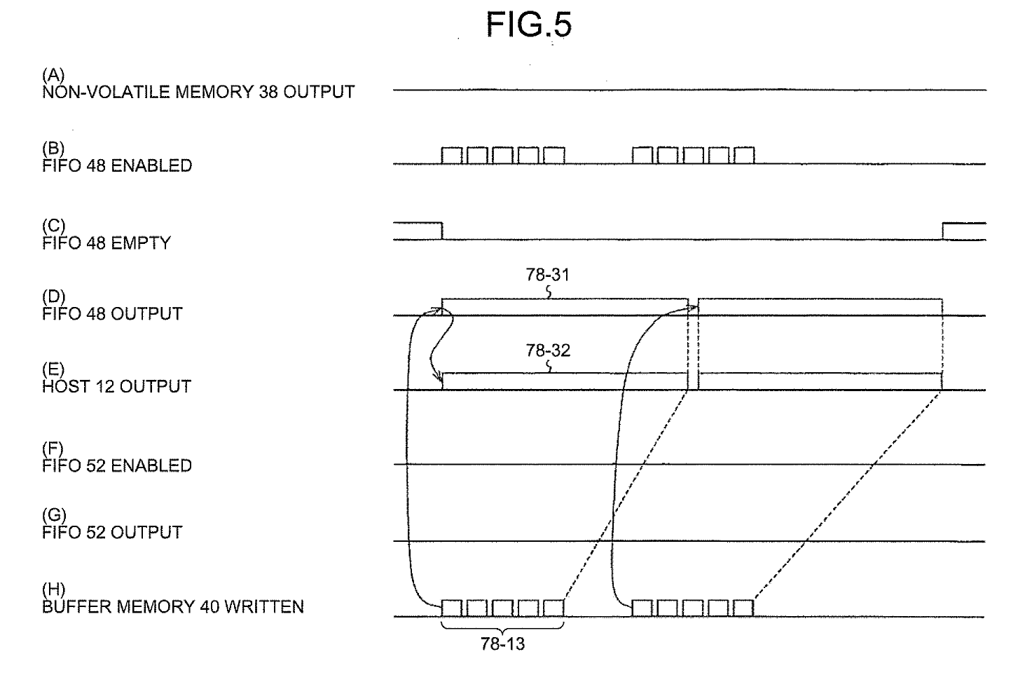

FIG. 5 is a timing chart illustrating the details of the transmission of data to the host when a cache hit occurs in the buffer memory 40 illustrated in FIG. 4. In FIG. 5, when there is a cache hit, as illustrated in FIG. 5(H), the transfer data 78-13 is continuously output from the buffer memory 40 in units of burst length.

In this case, the FIFO 48 receives initial transfer data with a burst length from the buffer memory 40, as illustrated in FIG. 5(B), and the empty state of the FIFO 48 is turned off as illustrated in FIG. 5(C). As illustrated in FIG. 5(D), the transfer data with a burst length from the buffer memory 40 is written in synchronization with the enable signal of the FIFO 48.

At the same time, as illustrated in FIG. 5(D), since the data transmission speed of the FIFO 48 to the host is high, the FIFO 48 continuously outputs the transfer data 78-31. As illustrated in FIG. 5(E), the output data are continuously transferred as transfer data 78-32 from the host interface controller 50 to the host 12.

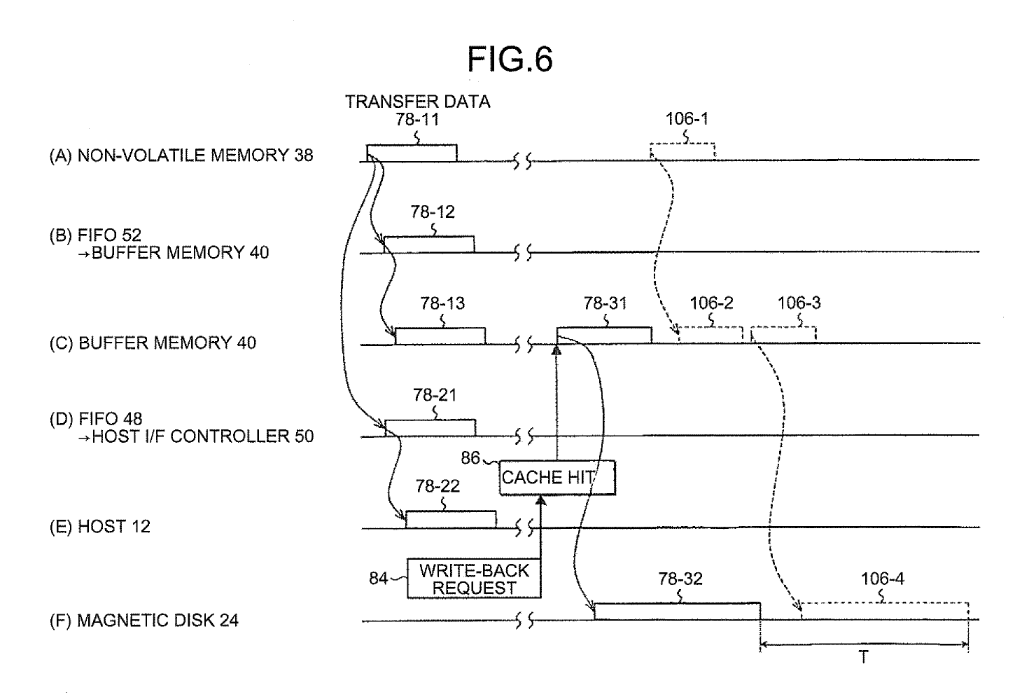

FIG. 6 is a timing chart illustrating data transmission when a cache hit occurs in response to a write-back request for the non-volatile memory 38 according to this embodiment.

The first half of FIGS. 6(A) to 6(F) illustrates the transmission of data to the host 12 and the buffer memory 40 in response to an initial read request 75 illustrated in FIGS. 2(A) to 2(E). It is assumed that a write-back request 84 is issued for the data of the non-volatile memory 38 which is the same as the transfer data 78-13 written to the buffer memory 40.

In the write-back process for the write-back request 84 illustrated in FIG. 1, the cache controller 72 searches whether there is corresponding data in the primary cache 74 of the buffer memory 40. When a cache hit 86 is received as the search result, as illustrated in FIG. 6(C), a request to read the transfer data 78-31 from the buffer memory 40 is issued, and the data are transferred and written as transfer data 78-32 to a magnetic disk 24, as illustrated in FIG. 6(F).

As such, when a cache hit occurs in the primary cache 74 of the buffer memory 40 in response to a write-back request to write back the data read from the non-volatile memory 38 to the magnetic disk, it is possible to reduce a process time corresponding to the period T, as compared to the write process according to the related art in which transfer data 106-1 is read from the non-volatile memory 38 and is then stored as transfer data 106-2 in the buffer memory 40, and the stored data are read as transfer data 106-3 and is then written as transfer data 106-4 to the magnetic disk 24.

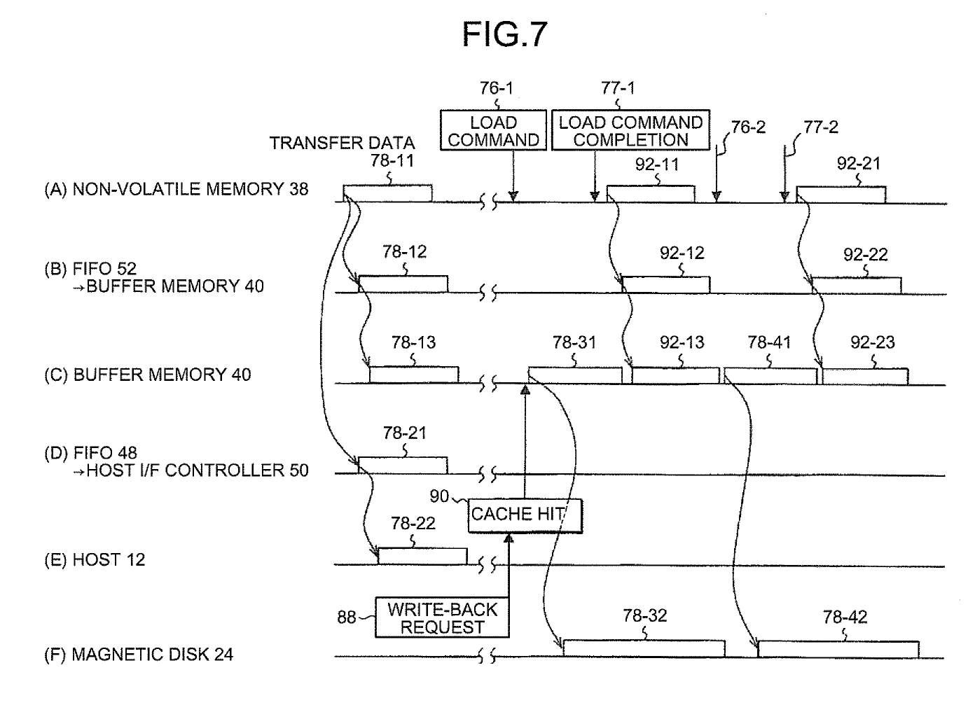

FIG. 7 is a timing chart illustrating a data transmission operation in which the idle time of the buffer memory is used to prefetch another data item from the non-volatile memory 38 to the primary cache 74 when data are continuously written back from the non-volatile memory to the magnetic disk in this embodiment.

The first half of FIGS. 7(A) to 7(F) illustrates a process when data are written back from the non-volatile memory 38 to the magnetic disk 24 and a cache hit 90 occurs in the primary cache 74 of the buffer memory 40, similar to FIG. 6. In the process, the transfer data 78-31 is read from the primary cache 74 of the buffer memory 40 and the transfer data 78-32 is written back to the magnetic disk 24.

The time for which the transfer data 78-31 is written to the buffer memory 40 is shorter than the time for which the transfer data 78-32 is written to the magnetic disk 24. Therefore, after the transfer data 78-31 is read from the buffer memory 40, an idle time occurs. Therefore, after the transfer data 78-32 is completely written to the magnetic disk 24, the next transfer data 78-41 is read from the buffer memory 40.

In this embodiment, at the read idle time between the transfer data 78-31 and the transfer data 78-41 from the buffer memory 40, another transfer data 92-11 is read from the non-volatile memory 38 and the read data are transferred as transfer data 92-11 from the FIFO 52 to the buffer memory 40 and is then written as transfer data 92-13 to the primary cache 74 of the buffer memory 40.

Specifically, when a write-back request 88 is issued, the load command 76-1 is issued to the non-volatile memory 38, as illustrated in FIG. 7(A), with the non-volatile memory 38 in a readable state. Then, issuance of the load command is completed (77-1) and the transfer data 92-11 is read from the non-volatile memory 38 and is then written as the transfer data 92-13 to the buffer memory 40 through the FIFO 52.

As the data written from the non-volatile memory 38 to the primary cache 74 of the buffer memory 40 during the read idle time of the buffer memory 40, data to be subjected to the MRU (Most Recently Used) management of the primary cache 74, that is, data of the non-volatile memory 38 subsequent to the latest data are read, transferred, and stored in the primary cache 74.

As such, during the idle time after the transfer data 78-31 is read from the buffer memory 40, the transfer data 92-13 that has been read and transferred from the non-volatile memory 38 is stored and the subsequent transfer data 78-41 is read and written as transfer data 78-42 to the magnetic disk 24.

In this case, during the next idle time, the load command 76-2 is issued to the non-volatile memory 38 such that data can be read therefrom, and issuance of the load command is completed (77-2). Then, transfer data 92-21 is read and the read data are written as transfer data 92-23 to the primary cache 74 of the buffer memory 40.

As such, when data are written back from the non-volatile memory 38 to the magnetic disk 24 and there is a cache hit in the buffer memory 40, during the buffer idle time in the reading and transmission of data from the buffer memory 40 to the magnetic disk 24, it is possible to transfer another data item read from the non-volatile memory 38 to the buffer memory 40 and store the data item as prefetch cache data in the primary cache 74. In addition, it is possible to make the cache data of the primary cache 74 provided in the buffer memory 40 in a data state in which a cache hit occurs easily in response to an access request from the host. Therefore, a cache hit is more likely to occur in the primary cache 74. As a result, it is possible to improve the overall access performance of a magnetic disk device.

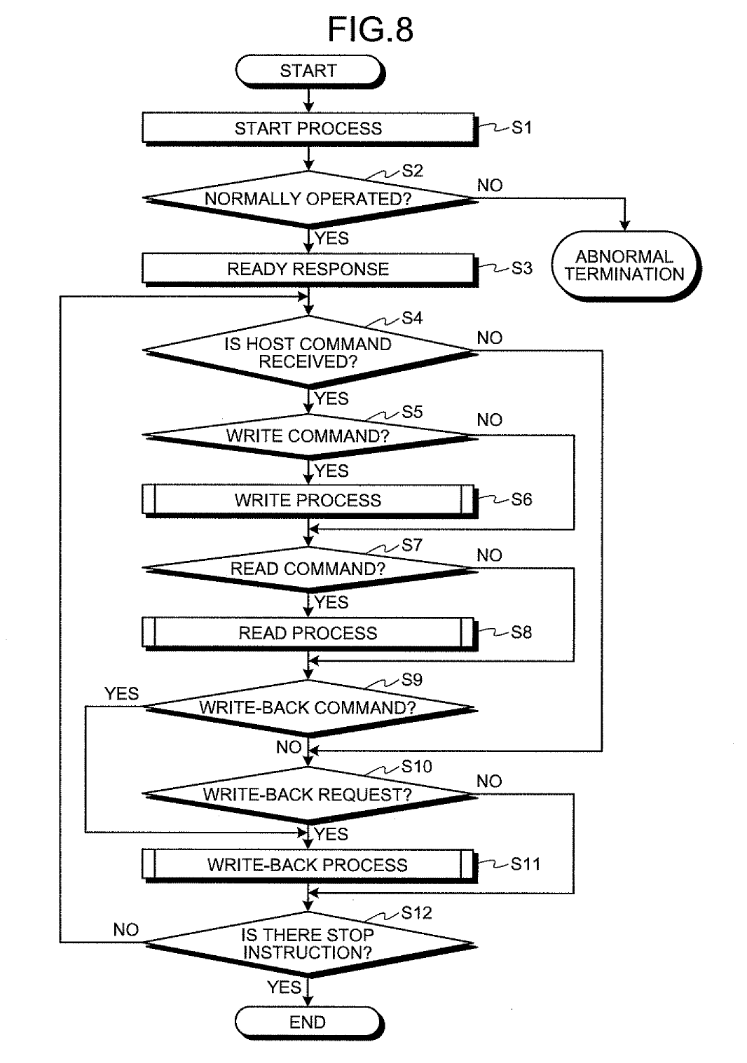

FIG. 8 is a flowchart illustrating a control process of the magnetic disk device according to this embodiment. The control process will be described with reference to FIG. 1 as follows.

In FIG. 8, first, when the host 12 illustrated in FIG. 1 starts up, the magnetic disk device 10 is turned on and a start process is performed in S1. When the magnetic disk device 10 is normally operated in S2, the magnetic disk device 10 transmits a ready response to the host 12 in S3 and is changed to an accessible state.

Then, in S4, the magnetic disk device 10 checks whether a command is received from the host 12 and proceeds to S5 to receive a command. When it is determined in S5 that a write command is received, the magnetic disk device 10 proceeds to S6 and performs a write process.

When it is determined in S7 that a read command is received, the magnetic disk device 10 proceeds to S8 and performs a read process. When it is determined in S9 that a write-back command is received, the magnetic disk device 10 proceeds to S11 and performs a write-back process.

When it is determined in S10 that the access controller 65, which is the firmware of the magnetic disk device, issues a write-back request, the magnetic disk device 10 performs the write-back process in S11. S4 to S11 are repeatedly performed until a stop instruction to log off the host 12 is issued in S12.

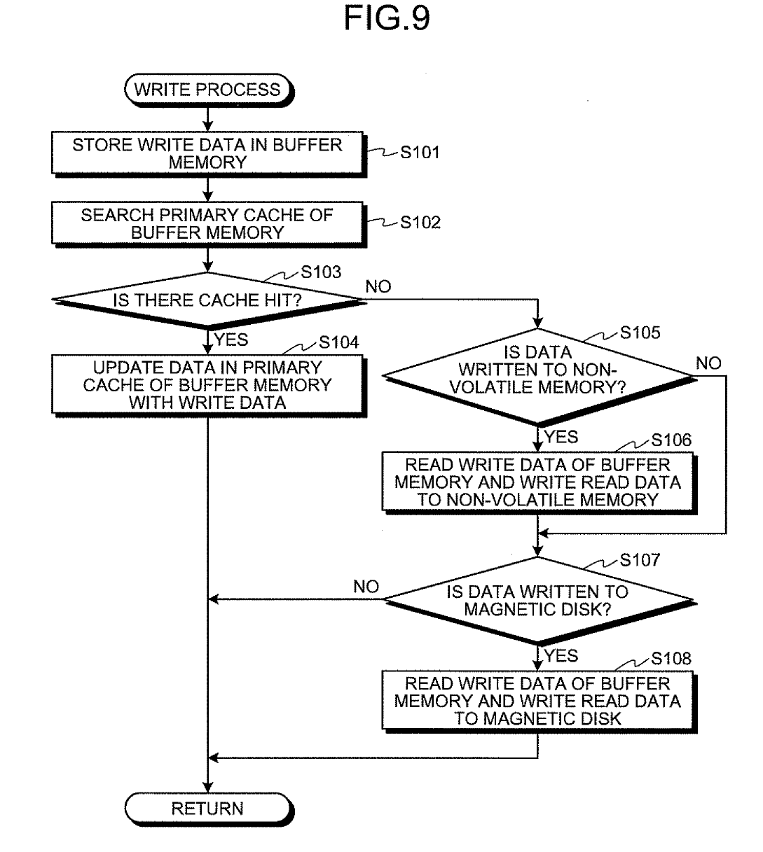

FIG. 9 is a flowchart illustrating the details of the write process in S6 of FIG. 8. In FIG. 9, the write processor 68 provided in the access controller 65 illustrated in FIG. 1 decodes the write command and performs the write process.

In FIG. 9, in the write process, the write data received from the host 12 in S101 is stored in the buffer memory 40 through the host interface controller 50, the arbiter 54, and the memory interface 56.

Then, in S102, the cache controller 72 searches whether there is corresponding data in the primary cache 74 based on the management data of the primary cache 74 in the buffer memory 40.

If it is determined in S103 that there is a cache hit in the primary cache 74, in S104, the write data received from the host 12 is overwritten on the corresponding data of the primary cache 74 to update the data. For the data update of the primary cache 74, the write-back flag of the updated data are set.

On the other hand, if it is determined in S103 that there is a cache miss hit, the process proceeds to S105 to check whether data are written to the non-volatile memory 38. When a write destination is the non-volatile memory, write data are read from the buffer memory 40 and is then written to the non-volatile memory 38 through the arbiter 54, the FIFO 52, the branch path controller 46, and the memory interface 42 (S106).

In this case, the cache controller 72 searches whether there is corresponding data in the secondary cache 73 of the non-volatile memory 38. When there is a cache hit in the secondary cache 73, the cache controller 72 overwrites the write data transferred from the buffer memory 40 on the data of the secondary cache 73 to update the data, and sets the write-back flag to the updated data. When there is a cache miss hit in the secondary cache 73, the write data are written in an empty region of the non-volatile memory 38.

When the write destination is not the non-volatile memory 38 in S105, it is determined in S107 whether data are written to the magnetic disk. In S108, the write data are read from the buffer memory 40, and the read data are transmitted to the sector buffer 60 through the arbiter 54. Then, the data are transmitted to the read channel 64 through the hard disk controller 62, and the read channel 64 modulates the data. The modulated data are transmitted to the head 26-1 that has been selected by the head IC 28, and the head 26-1 writes the write data to a target track of the magnetic disk 24-1.

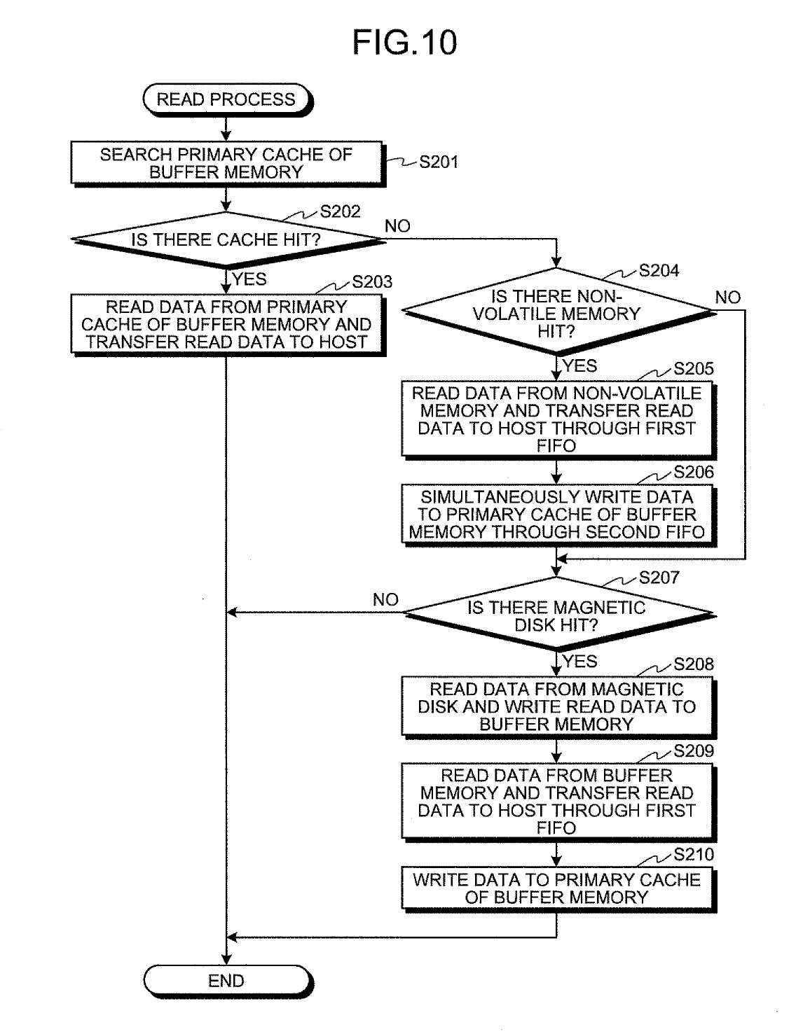

FIG. 10 is a flowchart illustrating the details of the read process in S8 of FIG. 8. The read process will be described with reference to FIG. 1 as follows. First, in S201, the read processor 66 provided in the access controller 65 illustrated in FIG. 1 requests the cache controller 72 to search whether there is corresponding data in the management data of the primary cache 74 of the buffer memory 40 based on the analysis result of the read command received from the host 12.

If it is determined in S202 that there is a cache hit in the primary cache 74, in S203, the read processor 66 reads data from the primary cache 74 and transmits the read data to the host interface controller 50 through the arbiter 54 and the FIFO 48. Then, the host interface controller 50 transfers the data to the host 12.

On the other hand, if it is determined in S202 that there is a cache miss hit, the read processor 66 proceeds to S204 and checks whether there is corresponding data in the non-volatile memory 38. If it is determined that there is corresponding data in the non-volatile memory 38, the read processor 66 proceeds to S205. Then, the read processor 66 reads the corresponding data from the non-volatile memory 38 and transmits the read data to the host interface controller 50 through the branch path controller 46 and the FIFO 48. The host interface controller 50 transfers the data to the host 12.

At the same time, the data are transferred from the branch path controller 46 to the buffer memory 40 through the FIFO 52 and the arbiter 54 and is then written to the primary cache 74 (S206).

If it is determined in S204 that there is no corresponding data in the non-volatile memory (miss hit) and it is determined in S207 that there is the corresponding data in the magnetic disk, in S208, the data are read from the magnetic disk and is then written to the buffer memory 40.

Then, in S209, data are read from the buffer memory 40 and the read data are transferred to the host interface controller 50 through the arbiter 54 and the FIFO 48. Then, the host interface controller 50 transfers the data to the host 12. In S210, the data transferred to the buffer memory 40 is written to the primary cache 74.

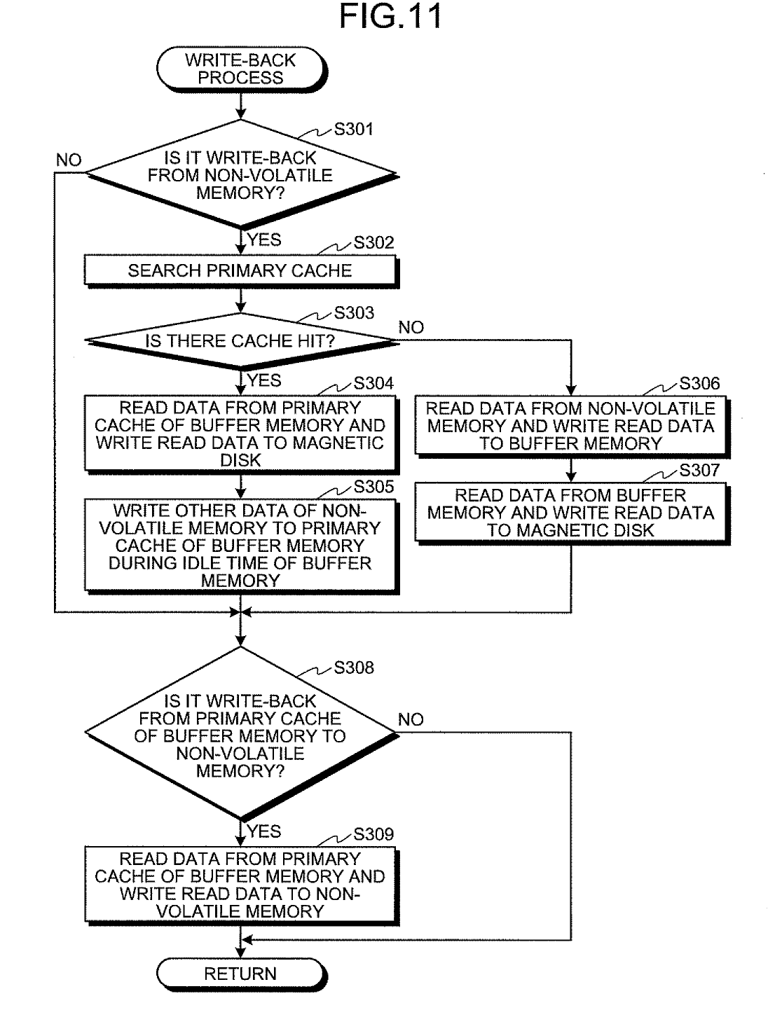

FIG. 11 is a flowchart illustrating the details of the write-back process in S11 of FIG. 8. The write-back process will be described with reference to FIG. 1 as follows.

In FIG. 11, the write-back processor 70 of the access controller 65 determines that a write-back command is received from the host 12, the PIN flag of data stored in the non-volatile memory 38 is reset, or there is a write-back request from the cache controller 72 by cache eviction from the secondary cache 73 by LRU management. Then, if it is determined in S301 that there is a write-back request or command to write back data from the non-volatile memory to the magnetic disk, the process proceeds to S302 to search whether there is write-back data in the primary cache 74 of the buffer memory 40.

Then, if it is determined in S303 that there is corresponding data in the primary cache 74 (cache hit), in S304, the data are read from the primary cache 74 and the read data are transferred and written to the corresponding magnetic disk.

In the write-back process in which data are read from the primary cache 74 of the buffer memory 40 and the read data are transferred and written to the magnetic disk, as illustrated in the timing chart of FIG. 7, there is an idle time in the data read operation from the buffer memory 40. Therefore, during the idle time, in S304, other data of the non-volatile memory 38, for example, data subsequent to the data of the primary cache 74 to be subjected to LRU management are read and the read data are written as prefetch data to the primary cache 74 (S305).

If it is determined in S303 that there is no data to be written back from the non-volatile memory to the magnetic disk in the primary cache 74 (cache miss hit), in S306, data are read from the non-volatile memory 38 and the read data are transferred and written to the buffer memory 40. Then, in S307, the data are read from the buffer memory 40 and the read data are transferred and written to the magnetic disk.

If it is determined in S308 that there is a write-back request or command to write back data from the primary cache 74 of the buffer memory 40 to the non-volatile memory 38, that is, there is a write-back request or command by cache eviction from the primary cache 74 by LRU management, in S309, data are read from the primary cache 74 and is then transferred to the non-volatile memory 38. Then, the data are written to the non-volatile memory 38.

The write-back operation of writing back data from the buffer memory 40 to the non-volatile memory 38 comprises an operation of overwriting data read from the primary cache 74 on the data stored in the non-volatile memory 38 and an operation of overwriting data read from the primary cache 74 on the data stored in the secondary cache 73 of the non-volatile memory 38.

Since the original data of the data stored in the secondary cache 73 is recorded on the magnetic disk, the write-back flag of the updated data are set by the writing-back of data to the secondary cache 73.

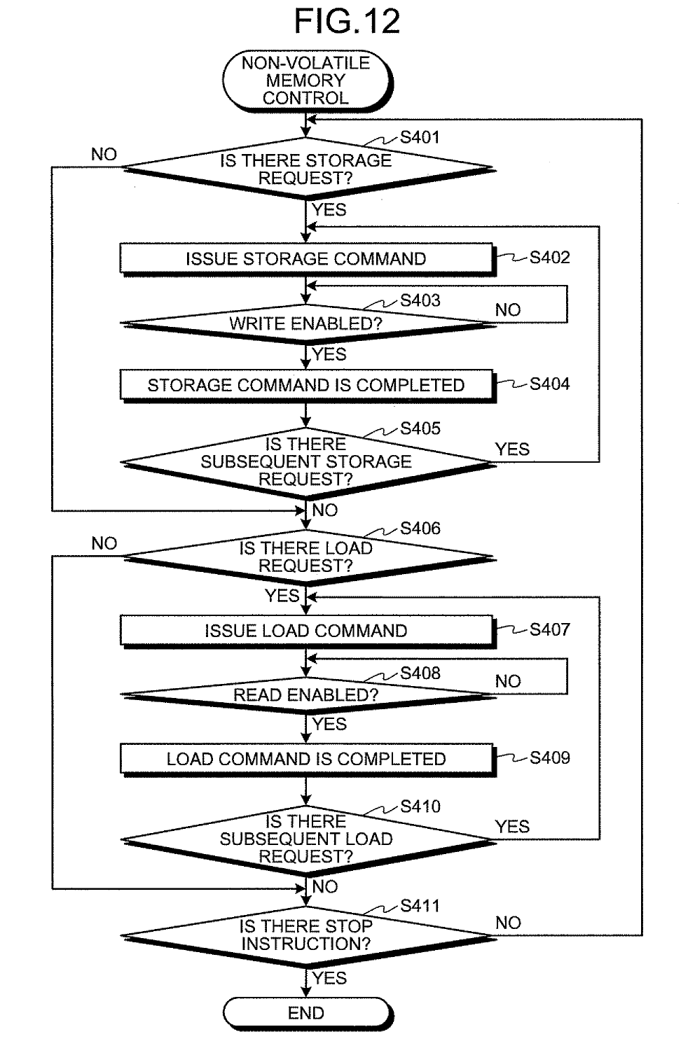

FIG. 12 is a flowchart illustrating the memory control of the non-volatile memory 38 according to this embodiment. The access controller 65 illustrated in FIG. 1 controls the memory interface 42 to perform the memory control.

In FIG. 12, in the non-volatile memory control process, if it is determined in S401 that there is a storage request, in S402, the access controller 65 issues a storage command to the memory interface 42. If it is determined in S403 that a write enable signal is received from the memory interface 42, in S404, issuance of the storage command is completed. If it is determined in S405 that there is a subsequent storage request, the access controller 65 repeatedly performs the process after S402.

If it is determined in S406 that there is a load request, in S407, the access controller 65 issues a load command to the memory interface 42. If it is determined in S408 that a read operation is enabled, in S409, issuance of the load command is completed.

If it is determined in S410 that there is a subsequent load request, the access controller 65 repeatedly performs the process after S407. S401 to S410 are repeatedly performed until an instruction to log off the host 12 is issued in S411.

The invention also provides a firmware program serving as the access controller of the MPU 30 illustrated in FIG. 1. The firmware program comprises the process content illustrated in the flowcharts of FIGS. 8 to 12.

The invention also provides a controller of a storage device. The controller of the storage device corresponds to a control circuit module 36 according to the embodiment illustrated in FIG. 1. The control circuit module 36 comprises the MPU 30, the memory interface 42, the branch path controller 46, the FIFO 48, the host interface controller 50, the FIFO 52, the arbiter 54, the memory interface 56, the sector buffer 60, the hard disk controller 62, and the read channel 64. The control circuit module 36 comprising these circuit modules is configured by one LSI.

In this embodiment, the control circuit module 36 is configured by one LSI. However, the hard disk controller and the read channel may be configured by separate LSIs, and the controller of the storage device may be composed of a control circuit comprising at least an MPU.

In addition, in this embodiment, the primary cache 74 is provided in the buffer memory 40. Therefore, when the host 12 is logged off and the magnetic disk device 10 is turned off, the primary cache 74 is erased.

A process of turning off power is performed after a write-back process is completed which writes back the data of the primary cache 74 whose write-back flag is set by the cache controller 72 to the corresponding data of the non-volatile memory 38 and the corresponding data of the secondary cache 73 provided in the non-volatile memory 38.

In this way, even when the primary cache 74 is provided in the buffer memory 40, which is a volatile memory, it is possible to prevent the damage of cache data in the primary cache 74 when power is turned off.

According to an embodiment of the invention, upon a read request from a host with respect to a nonvolatile memory, data read from the nonvolatile memory are transferred to the host concurrently with transferring of the read data to a buffer memory to be cached. Therefore, it is possible to transfer the data to the host without transferring the data via a buffer memory and thus to shorten the time to carry out the data transfer.

Further, since it is possible to cache the data to the buffer memory concurrently with the data transfer to the host by the reading from the nonvolatile memory, upon a subsequent read request for the same data with respect to the nonvolatile memory, it is possible to transfer the data from the buffer memory to the host and thus shorten the time to carry out the data transfer.

Further, upon generation of a request to write back from the nonvolatile memory to a disk medium, by transferring and writing back the data cached in the buffer memory to the disk medium, it is possible to shorten the time for the write-back as compared with the writing back to the disk medium from the nonvolatile memory via the buffer memory.

Further, if there is a request to write back from the nonvolatile memory to the disk medium, and the data are to be transferred from the buffer memory to the disk medium, the writing speed to the disk medium is slower than the reading speed from the buffer memory and thus a read idle time is generated in the buffer memory. By utilizing this idle time to read data that have not been cached from the nonvolatile memory and prefetch the read data to a cache, it is possible to increase a cache hit rate in the buffer memory for the data in the nonvolatile memory, and thus to shorten the access time for the overall storage device and improve the processing performance.

Various modifications and changes of the invention can be made without departing from the scope and spirit of the invention, and the invention is not limited to the numerical values of the above-described embodiment.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a head actuator configured to move a head to an arbitrary position on a disk medium;
a disk recording and reproducing module configured to record data to the disk medium or to reproduce the data from the disk medium using the head;
a non-volatile memory controller configured to write information to a non-volatile memory or to read the information from the non-volatile memory;
a buffer controller configured to write information to a buffer memory or to read the information from the buffer memory;
an upper interface controller configured to transmit a command and data to an upper device and to receive the command and data from the upper device;
a transfer path switch configured to switch data transfer paths among the disk recording and reproducing module, the non-volatile memory controller, and the upper interface controller; and
an access controller configured to control the transfer path switch to transfer the data from the non-volatile memory to the upper device concurrently by transferring and storing the read data in a cache region of the buffer memory, upon receiving from the upper device a data read command to read the data from the non-volatile memory.

2. The storage device of claim 1, wherein the transfer path switch comprises:
a branch path access controller configured to divide the data from the non-volatile memory into two paths to cause simultaneous transfer of the read data to the upper interface controller and the buffer controller;
a first queue between the branch path access controller and the upper interface controller;
a second queue between the branch path access controller and the buffer controller; and
an arbiter configured to switch and select any one of a transfer path between the first queue and the buffer controller, a transfer path between the second queue and the disk recording and reproducing module, and a transfer path between the buffer controller and the disk recording and reproducing module.

3. The storage device of claim 2, wherein storage capacities of the first queue and the second queue are at least twice as large as a data write unit size with respect to the buffer memory.

4. The storage device of claim 1, wherein
the access controller is configured to search for corresponding data in the cache region of the buffer memory upon receiving from the upper device the data read command to read the data from the non-volatile memory, and
the access controller is configured to read the corresponding data from the cache region and to transfer the corresponding data to the upper device if the corresponding data are in the cache region.

5. The storage device of claim 1, wherein
the access controller is configured to search for corresponding data in the cache region of the buffer memory upon either receiving a write-back command to write data back from the non-volatile memory to the disk medium from the upper device or generating a write-back request, and
the access controller is configured to read the corresponding data from the cache region and writes back the read corresponding data to the disk medium if the corresponding data are in the cache region.

6. The storage device of claim 5, wherein the access controller is configured to transfer data that have not been cached in the cache region of the buffer memory from the non-volatile memory and to store the data in a read idle time of the buffer memory while writing data back from the cache region to the disk medium.

7. A storage control device comprising:
a disk recording and reproducing module configured to record data to a disk medium or to reproduce the data from the disk medium using a head;
a non-volatile memory controller configured to write information to a non-volatile memory or to read the information from the non-volatile memory;
a buffer controller configured to write information to a buffer memory or to read the information from the buffer memory;
an upper interface controller configured to transmit a command and data to an upper device and to receive the command and data from the upper device;
a transfer path switch configured to switch data transfer paths among the disk recording and reproducing module, the non-volatile memory controller, and the upper interface controller; and
an access controller configured to control the transfer path switch to transfer the data from the non-volatile memory to the upper device concurrently by transferring and storing the read data in a cache region of the buffer memory, upon receiving from the upper device a data read command to read the data from the non-volatile memory.

8. The storage control device of claim 7, wherein the transfer path switch comprises:
a branch path access controller configured to divide the data from the non-volatile memory into two paths to cause simultaneous transfer of the read data to the upper interface controller and the buffer controller;
a first queue between the branch path access controller and the upper interface controller;
a second queue between the branch path access controller and the buffer controller; and
an arbiter configured to switch and select any one of a transfer path between the first queue and the buffer controller, a transfer path between the queue FIFO and the disk recording and reproducing module, and a transfer path between the buffer controller and the disk recording and reproducing module.

9. The storage control device of claim 8, wherein storage capacities of the first queue and the second queue are at least twice as large as a data write unit size with respect to the buffer memory.

10. The storage control device of claim 7, wherein,
the access controller is configured to search for corresponding data in the cache region of the buffer memory upon receiving from the upper device the data read command to read the data from the non-volatile memory, and
the access controller is configured to read the corresponding data from the cache region and to transfer the corresponding data to the upper device if the corresponding data are in the cache region.

11. The storage control device of claim 7, wherein
the access controller is configured to search for corresponding data in the cache region of the buffer memory upon either receiving a write-back command to write data back from the non-volatile memory to the disk medium from the upper device or generating a write-back request, and
the access controller is configured to read the corresponding data from the cache region and writes back the read corresponding data to the disk medium if the corresponding data are in the cache region.

12. The storage control device of claim 11, wherein the access controller is configured to transfer data that have not been cached in the cache region of the buffer memory from the non-volatile memory and to store the data in a read idle time of the buffer memory while writing data back from the cache region to the disk medium.

13. A method of controlling a storage device, the method comprising:
moving a head to an arbitrary position on a disk medium;
recording data to the disk medium using the head;
reproducing the data from the disk medium using the head;
writing information to a non-volatile memory;
reading the information from the non-volatile memory;
writing information to a buffer memory;
reading the information from the buffer memory;
transmitting a command and data to an upper device;
receiving the command and data from the upper device;
switch data transfer paths; and
controlling the transfer path switching to transfer data read from the non-volatile memory to the upper device concurrently with transferring and storing the read data in a cache region of the buffer memory, upon receiving from the upper device a data read command to read the data from the non-volatile memory.

14. The method of claim 13, further comprising:
dividing the data read from the non-volatile memory into two paths to transfer simultaneously the read data;
providing a first queue;
providing a second queue; and
switching and selecting any one of a transfer path from the first queue, a transfer path from the second queue, and a transfer path from a buffer controller to write the information to the buffer memory.

15. The method of claim 14, wherein storage capacities of the first queue and the second queue are at least twice as large as a data write unit size with respect to the buffer memory.

16. The method of claim 13, further comprising:
searching corresponding data from the cache region of the buffer memory upon receiving from the upper device the data read command to read the data from the non-volatile memory; and
reading the corresponding data from the cache region and transferring to the upper device if the corresponding data are in the cache region.

17. The method of claim 13, further comprising:
searching corresponding data from the cache region of the buffer memory upon either receiving a write-back command to write back from the non-volatile memory to the disk medium from the upper device or generating a write-back request;
reading the corresponding data from the cache region if the corresponding data are in the cache region; and
writing the read data back to the disk medium.

18. The method of claim 17, further comprising:
transferring data that have not been cached from the non-volatile memory to be stored in the cache region of the buffer memory in a read idle time of the buffer memory while data are being written back from the cache region to the disk medium.

19. A controller for a storage device that comprises:
a head actuator configured to move a head to an arbitrary position on a disk medium;
a disk recording and reproducing module configured to record to the disk medium or to reproduce the data from the disk medium using the head;
a non-volatile memory controller configured to write information to a non-volatile memory or to read the information from a non-volatile memory;
a buffer controller configured to write information to a buffer memory or to read information from the buffer memory; and
an upper interface controller configured to transmit a command and data to an upper device and to receive the command and data from an upper device,
wherein the controller comprises:
a transfer path switch controller configured to switch data transfer paths among the disk recording and reproducing module, the non-volatile memory controller, and the upper interface controller; and
an access controller configured to control the transfer path switch to transfer the data from the non-volatile memory to the upper device concurrently by transferring and storing the read data in a cache region of the buffer memory, upon receiving from the upper device a data read command to read the data from the non-volatile memory.
